(19) United States
(12) Patent Application Publication
(10) Pub. No.: US 2018/0049398 A1
(43) Pub. Date: Feb. 22, 2018

(54) Vehicle Pet Holder

(71) Applicant: Sharolyn Brown, Gulfport, MS (US)

(72) Inventor: Sharolyn Brown, Gulfport, MS (US)

(21) Appl. No.: 15/678,875

(22) Filed: Aug. 16, 2017

Related U.S. Application Data
(60) Provisional application No. 62/375,492, filed on Aug. 16, 2016.

(51) Int. Cl. A01K 1/00; A01K 1/06; B60R 7/04

(52) U.S. Cl. CPC A01K 1/0035; B60R 7/046; A01K 1/06

(57) ABSTRACT

A vehicle pet holder. The vehicle pet holder provides a basket that is mountable to the interior of a vehicle for safely positioning a pet within. The basket securely affixes to the interior of a vehicle for transit via one or more hooks. The basket includes a sidewall that forms an interior volume for housing the pet. The hooks extend from the sidewall and are configured to mountably affix the basket to an interior side of a vehicle door. A harness is selectively attachable to fit to a torso of the pet. The harness includes a fastener and a strap which can be removably coupled to the basket.

### CROSS REFERENCE TO RELATED APPLICATION

This application claims the benefit of U.S. Provisional Application No. 62/375492 filed on Aug. 16, 2016. The above identified patent application is herein incorporated by reference in its entirety to provide continuity of disclosure.

### BACKGROUND OF THE INVENTION

### Field of the Invention

The present invention relates to a pet holder. More specifically, the present invention provides vehicle pet holder having a basket that is configured to be mountable to an interior side of a vehicle door via one or more hooks.

Devices have been disclosed in the known art that relate to vehicle pet holders. These include devices that have been patented and published in patent application publications. These devices in the known art have several known drawbacks. For example, these known vehicle pet holders fail to provide hooks for attaching to an interior side of a vehicle door and a pet harness for connecting therewith. In this way, the present invention allows for a secured pet to be safely positioned adjacent a vehicle window within the holder.

In light of the devices disclosed in the known art, it is submitted that the present invention substantially diverges in design elements from the devices in the known art and consequently it is clear that there is a need in the art for an improvement to existing vehicle pet holder devices. In this regard, the instant invention substantially fulfills these needs.

### SUMMARY OF THE INVENTION

In view of the foregoing disadvantages inherent in the known types of vehicle pet holders now present in the art, the present invention provides a new vehicle pet holder wherein the same can be utilized for providing convenience for the user when safely positioning a pet therein, and securely affixed to an interior of a vehicle for transit. The vehicle pet holder includes a basket having a sidewall that forms an interior volume for housing the pet. One or more hooks extend from the sidewall, wherein the hooks are configured to mountably affix the basket to an interior side of a vehicle door. A harness is selectively attachable to fit to a torso of the pet. The harness includes a fastener, wherein a strap can removably couple to the fastener and affix the harness to the basket.

It is therefore an object of the present invention to provide a new and improved vehicle pet holder configured to operable connect a pet harness to the basket for preventing falling of a pet positioned within the interior volume thereof.

It is another object of the present invention to provide a J-shaped hook that allows the basket to mount flush with the interior side of the door.

Another object of the present invention is to provide a vehicle pet holder that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the vehicle pet holder mounted to an interior side of a vehicle door.

FIG. 2 shows a side view of the vehicle pet holder mounted to an interior side of a vehicle door.

FIG. 3 shows a cross sectional view of the vehicle pet holder taken along line 3-3 of FIG. 1.

FIG. 4 shows a pet harness of the vehicle pet holder with fasteners disposed thereon.

### DETAILED DESCRIPTION OF THE INVENTION

Reference is made herein to the attached drawings. Like reference numerals are used throughout the drawings to depict like or similar elements of the vehicle pet holder. For the purposes of presenting a brief and clear description of the present invention, the preferred embodiment will be discussed as used for vehicle pet holder. The figures are intended for representative purposes only and should not be considered to be limiting in any respect.

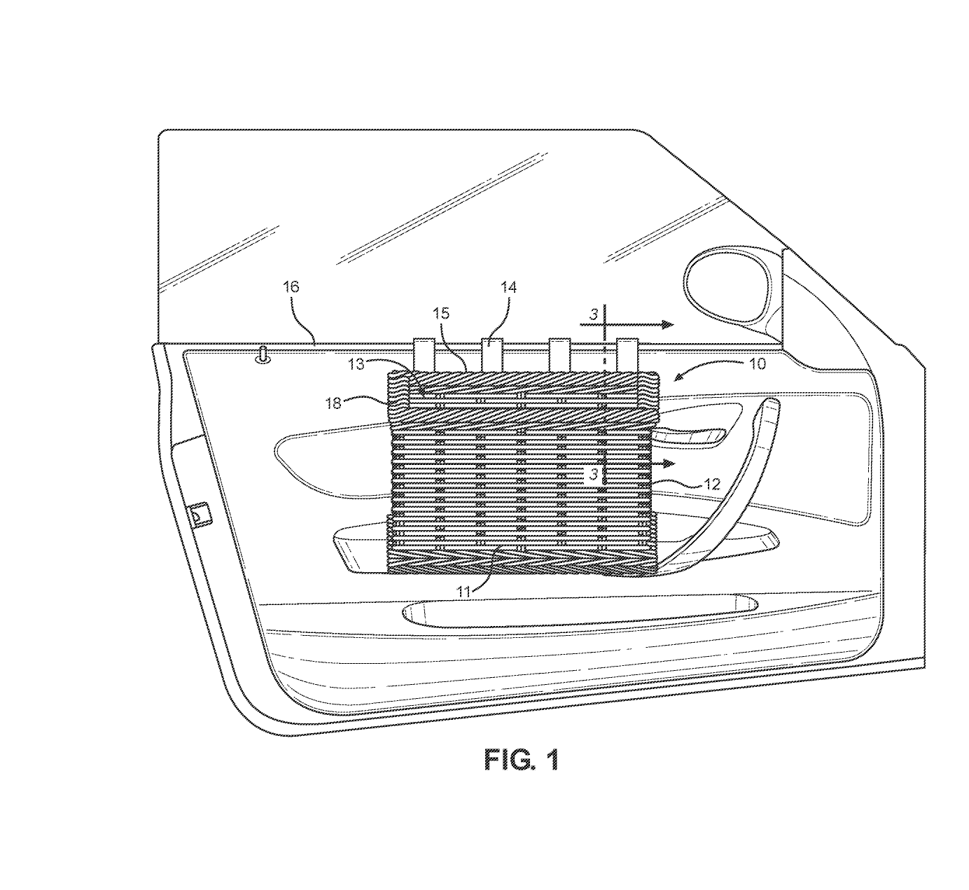

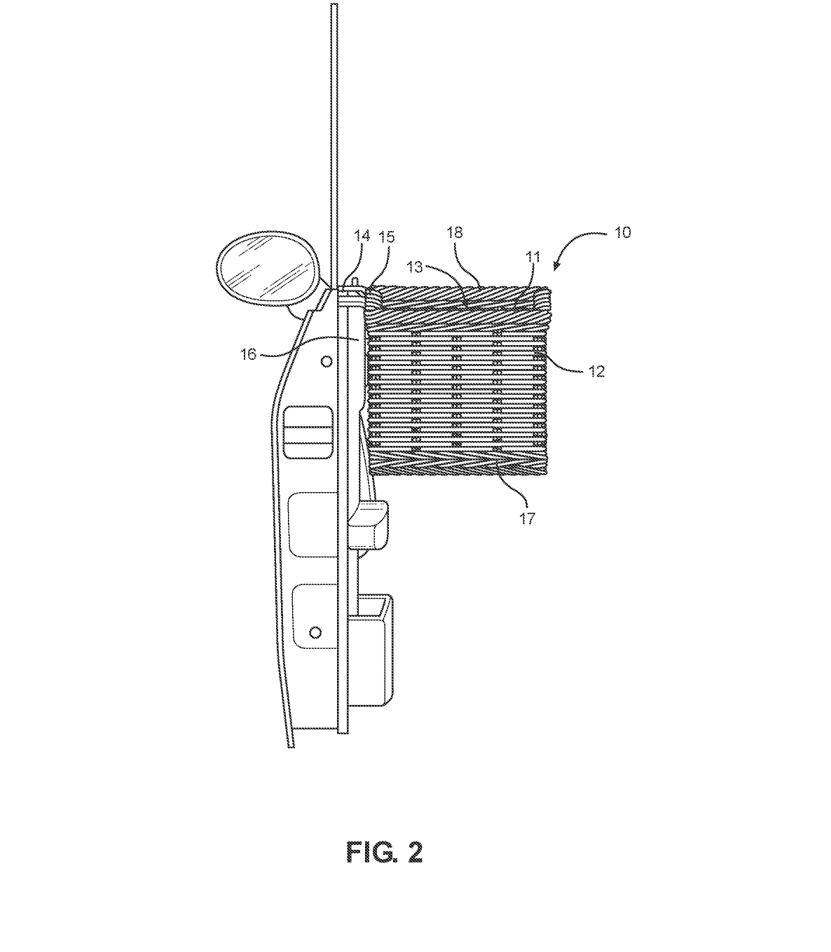

Referring specifically to FIGS. 1 and 2, there is shown a perspective view and a side view of the vehicle pet holder mounted to an interior side of a vehicle door, respectively. The vehicle pet holder 10 provides a device for attaching to an interior of a vehicle, specifically to an interior side 16 of a vehicle door that allows a pet to be positioned safely therein. The vehicle pet holder 10 comprises a basket 11 having a sidewall 12 forming an interior volume 13, wherein the basket 11 is adapted to support a pet therein. One or more hooks 14 extend from the sidewall 12 of the basket 11 and each hook 14 is configured to mountably affix the basket 11 to an interior side of a vehicle door. In the shown embodiment, the hooks 14 extend from a first side 15 of the basket 11, and extend past an upper end 18 of the sidewall 12.

In the shown embodiment, the basket 11 comprises an oval or circular shape. However, in alternative embodiments, the basket 11 may have rectangular or other shape adapted to house a pet therein. Additionally, a blanket 17 is removable positionable over an interior surface of the basket 11. In one embodiment, the blanket 17 is removable positionable via one or more fasteners, such as hook and loop fasteners, that secure the relative position of the blanket 17 within the interior volume 13 thereof. In one embodiment, the one or more hooks 14 comprise four hooks disposed on the first side 15 of the basket 11, wherein each of the four hooks are spaced at fixed intervals therealong. In this way, the basket 11 is supported evenly. In addition, each of the hooks 14 are dimensionally similar or identical.

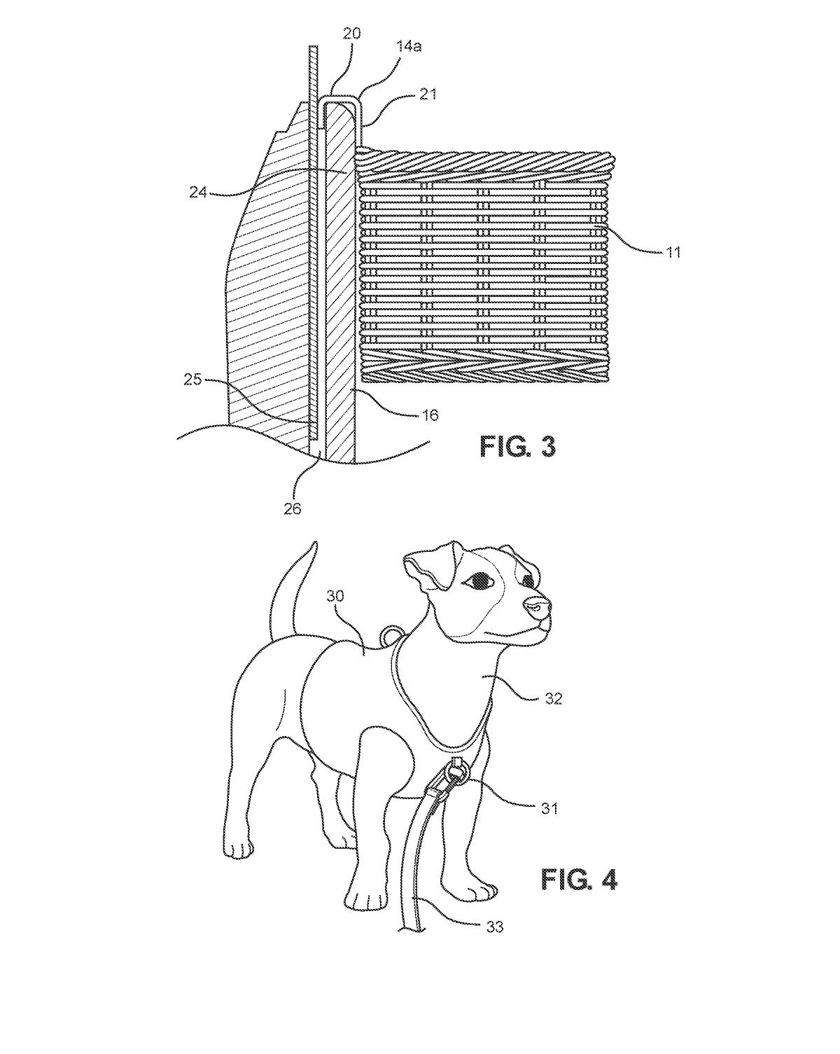

Referring specifically to FIG. 3, there is shown a cross sectional view of the vehicle pet holder taken along line 3-3 of FIG. 1. In the shown embodiment, the vehicle pet holder 11 includes one or more hooks 14 that each comprises one or more inverted J-shaped hooks 14A. Each of the J-shaped hooks 14A include a first member 20 disposed perpendicular to a second member 21, wherein the second member 21 is perpendicular to the sidewall 12. Further, the first member 20 of the one or more inverted J-shaped hooks 14A vertically offsets the basket 11 at a height 22 from the second member 21. The height 22 allows a pet positioned within the basket 11 to remain safely within the vehicle pet holder 10 while maintaining a view out of the vehicle through the vehicle door window.

In the shown embodiment, the second member 21 has a length 23 configured to rest a first side 15 of the basket 11 flush with the interior side 16 of the vehicle door. The one or more hooks 14 are configured to fit between a gap 24 formed between a door vehicle window 25 and door vehicle window compartment 26. As shown, the first member 20 is configured to engage the interior side 16 of the vehicle door by selectively positioning within the gap 24 of the vehicle door such that the basket 11 is in a cantilever position thereto and is adapted to support a pet therein.

Referring specifically to FIG. 4, there is shown a pet harness of the vehicle pet holder with fasteners disposed thereon. The pet harness 30 is configured to removably fit around a torso or body of the pet 32. The pet harness 30 includes a fastener 31 that allows the harness 30 to be removably and selectively affixed to the basket 11 via a strap 33. In the shown embodiment, the strap 33 is removably coupled to the fastener 31 disposed on a back panel thereof, such that the pet 32 is safely disposed within the basket 11 via connection to the harness 30.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A vehicle pet holder, comprising:
a basket having a sidewall forming an interior volume;
one or more hooks extending from the sidewall, the hooks configured to mountably affix the basket to an interior side of a vehicle door;
a harness configured to removably fit around a torso of the pet; and
the harness including a fastener, wherein a strap removably coupled to the fastener is configured to affix the harness to the basket.

2) The vehicle pet holder of claim 1, the interior volume wherein the one or more hooks extends from a first side of the basket, and extend past an upper end of the sidewall.

3) The vehicle pet holder of claim 1, comprising thermoplastic polymer.

4) The vehicle pet holder of claim 1, wherein the one or more hooks comprises one or more inverted J-shaped hooks having a first member disposed perpendicular to a second member, wherein the second member is perpendicular to the sidewall.

5) The vehicle pet holder of claim 4, wherein the second member has a length configured to rest a first side of the basket flush with the interior side of the door, the first member configured to engage the interior side of the vehicle door.

6) The vehicle pet holder of claim 4, wherein the first member of the one or more inverted J-shaped hooks vertically offset the basket at a height from the second member.

7) The vehicle pet holder of claim 1, wherein the one or more hooks comprise four hooks disposed on a first side, the four hooks spaced at intervals therealong.

8) The vehicle pet holder of claim 7, wherein the four hooks are dimensionally similar.

9) The vehicle pet holder of claim 1, wherein the one or more hooks are configured to fit between a gap formed between a door vehicle window and door vehicle window compartment.

10) The vehicle pet holder of claim 1, further comprising a blanket removably affixed to the basket, wherein the blanket covers an interior side thereof.
